(19) United States
(12) Patent Application Publication
(10) Pub. No.: US 2007/0113291 A1
(43) Pub. Date: May 17, 2007

(54) Method for administrating the function access

(76) Inventors: Juin-Jia Dai, Hukou Township (TW); Hung-Lin Chou, Zhonghe City (TW); Chia-Ching Lin, Chaozhou Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/280,233

(22) Filed: Nov. 17, 2005

(51) Int. Cl. H04L 9/32; H04L 9/00; G06F 17/30; H04K 1/00; G06F 7/04; G06K 9/00; H03M 1/68; H04N 7/16

(52) U.S. Cl. 726/27; 713/182; 713/165; 713/167

(57) ABSTRACT

A method for examining a user's identity and/or administrating the access right(s) of a called function is disclosed. Before the called function is functioned in a computer system, the method redirects the executing procedure to an interception means, which further processes a user's identity verification and/or the access right(s) examination. Next, after confirming the identity and/or the access right(s), the called function is functioned. For example, by modifying the preceding operation codes, the called function can jump to the means for intercepting; a corresponding entry of executable file dynamic library import table is modified; a method for replacing the library with called function to be intercepted is introduced; and a callback function is provided to redirect the executing procedure to an identity verification/access control unit.

### BACKGROUND OF THE INVENTION

1. Field of the Invention

A method for examining a user's identity and/or administrating the access right(s) of a called function is provided, more particularly to a user's identity and/or access rights examination as calling a function.

2. Description of Related Art

In the subject of computer operation and directory/file management of the conventional art, the administrator therefor should need to utilize a specific method or a mechanism to verify a user's identity and his operative permission. After the identification, the user can be authorized to do the computation operation or the related directory/file accessing, such as the operation of reading, writing, modifying, copying, printing or the like functions. Since the user operates the various computer operations or any data accessing, for security issue, some daemons (programs) run as the background processes in response to administrate the authentication or authorization of the run-time operations.

For the above-mentioned manner applying to identification or authorization in a computer system, such as the Linux operating system or other UNIX-like OSs, the user management means is used to identify the permission for data accessing inherently. Under any multi-user operating system, the user management is a full-time and requisite task. Whereby, the user being created in the operating system is authorized to use a function-call to process some system functions, such as read, write, execute or the like.

For some intercepting methods provided in the prior art, especially in Microsoft Windows system (by Microsoft Corporation of Redmond, Wash.), an activation module is first executed at system initialization time, such as the disclosure in U.S. Patent Pub. No. 2002/0019887. Wherein, the activation module of the Windows system is used to parse user configuration information supplied in a configuration file, and parse whether a function call is required to be intercepted. After that, the function calls is redirected to an interception module, such as the Dynamic Library Hooking technology of the Windows system is used to hook the system APIs (Application Program Interface).

More, U.S. Patent Pub. No. 2002/0029374 further depicts the generalized program hooks. In which, a hook interface module cooperates with a Linux kernel whose functionality is to be modified, thereby, the hook interface module is used to resolve a memory address and maintain the modification functions.

U.S. Pat. No. 6,823,460 further discloses a method of intercepting application program interface within the user portion of an operating system. The operating system in this conventional skill includes a kernel space and a process space. While a user application is running in the process space, the user application uses an API function, and then the API function will be hooked and executed in the memory space. Reference is made to FIG. 1 showing a schematic illustration of the system environment wherein the API Interception System is operating. A system 10 comprises four major components of the API Interception System, three (1, 2, 3) of which are active and one (4) is passive, and an API Interception Control Server 16 is the operational center of this API Interception System 10. Initially, the API interception modules 4, 5 and 6 are loaded by the API Interception Control Server 16 into each active process address space 1, 2 and 3 in a user space. Further, a System Call Interception Component 7 operates in a kernel space 14 and is linked to API Interception Control Server 16 in the user space. Whereby, during its run-time operation API Interception Control Server 16 constantly monitors the host operating system for some system calls through the System Call Interception Component 7 and takes appropriate action according to the type of system calls detected.

However, in the reference of the above-mentioned system, since these operating systems provide the OS-level calling procedure as a user operates a system function, some specific hooking technologies are used for the particular operating system especially for identifying the user's authority to have the permission to operate the function calls. A method for examining a user's identity and/or administrating the access right(s) of a called function in the function-level provided by the present invention is disclosed.

### SUMMARY OF THE DISCLOSURE

The present invention relates to a method for examining a user's identity and/or administrating the access right(s) of a called function, the method is used to redirect the function call to an interception means before the called function is functioned. After confirming a user's identity and/or the access right(s), the called function is functioned.

For example, by modifying the preceding operation codes, the called function can be transferred to the means for intercepting and do the further identification and/or access right control. The process thereof comprises a step for modifying the called function within the memory space of a running program at first, and then the interception means is to intercept the execution of the called function. Further, the process has the steps for backing up the original preceding operation codes, modifying the preceding operation codes of the called function to transfer the executing procedure to an identity verification/access control unit while the called function is called, then after examining the user's identity and/or the access right(s) of the function-caller, the preceding operation codes are restored. Finally, the preceding operation codes are addressed in memory and being executed.

Next, a corresponding entry of executable file dynamic library import table disclosed in the embodiment is modified, further comprises a step for calling the called function, a step for redirecting the original executing procedure to an identity verification/access control unit, and the steps for examining a user's identity and/or the access right(s) to the called function, confirming the user's identity and/or the access right(s) of the function-caller, and finally transferring the executing procedure to the called function. Then, the called function is executed.

Next, a method for replacing the library with called function to be intercepted is introduced, the steps include calling a called function at first, and loading an external identity verification/access control library file with the identity verification/access control unit afterward. Then, a user's identity and/or the access right(s) to the called function are examined, and after confirmed, the executing procedure is transferred to the called function. The called function is executed.

Next, a callback function is provided to redirect the function call to an identity verification/access control unit, the steps further comprises a step for registering a callback function from a system supported hooking module, and triggering a function related to the callback function. After that, a step for calling callback function of the hooking mechanism is provided. A user's identity and/or the access right(s) to the called function are examined, and being confirmed in the callback function. The executing procedure is transferred to the called function and the called function is executed finally.

Next, a method for duplicating the operation codes to a new memory space is introduced, the steps include duplicating the operation codes of the called function and/or the whole/partial operation codes that are relative to the called function to a new memory space, modifying the preceding operation codes of the called function, and calling the called function to transfer the executing procedure to an identity verification/access control unit within the above-mentioned new memory space afterward. Then, a user's identity and/or the access right(s) to the called function are examined, and after confirmed, the executing procedure is transferred to the duplicated called function in the new memory space. The called function is executed in the new memory space.

Next, a method for replacing interrupt routine address of interrupt (vector) table is introduced, the steps include replacing interrupt routine address of the interrupt (vector) table by the address of the new interrupt handling routine (for the interrupt-based system call) to redirect any interrupt to an identity verification/access control unit, and calling a interrupt routine afterward. Then, a user's identity and/or the access right(s) to the interrupt routine are examined, and after confirmed, the executing procedure is transferred to the original called interrupt routine. The original interrupt routine is executed.

### BRIEF DESCRIPTION OF DRAWINGS

The present invention will be readily understood by the following detailed description in conjunction accompanying drawings, in which:

FIG. 1 shows a schematic illustration of the system environment wherein the API Interception System is operating of the prior art;

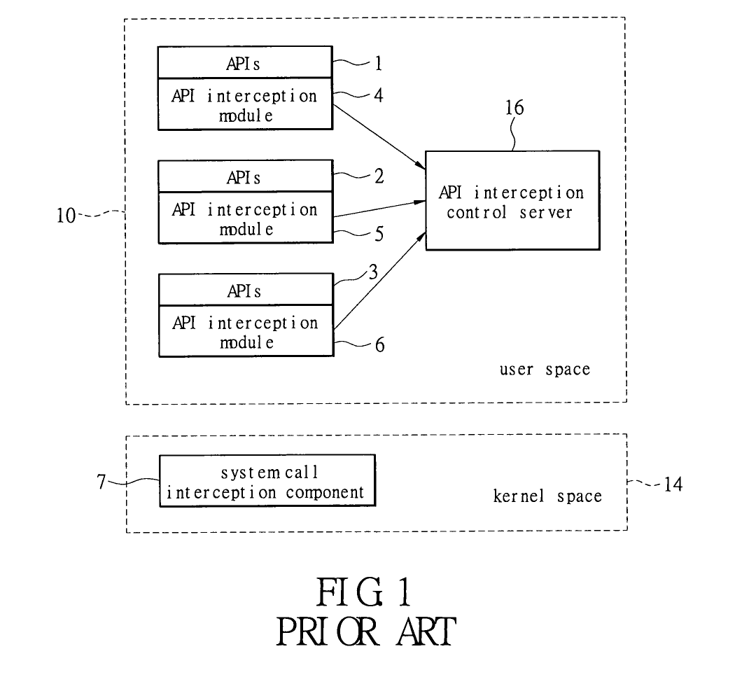

FIG. 2 is a schematic diagram of the preferred embodiment of the present invention;

FIG. 3 shows a flowchart of the method for administrating of the present invention;

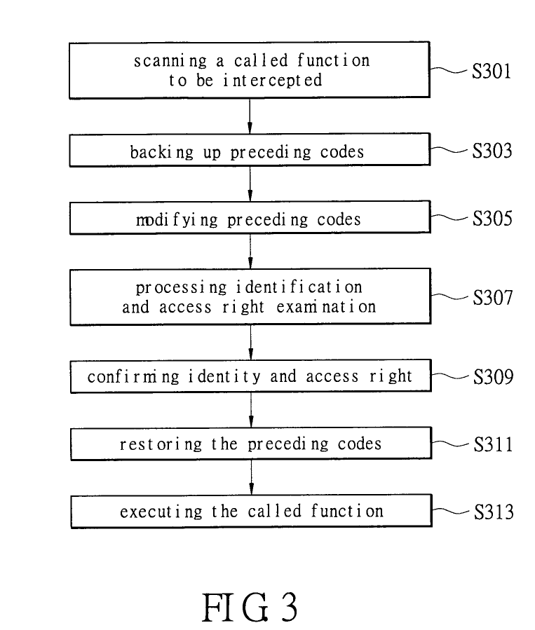

FIG. 4 shows a flowchart of the process disclosed in the present invention;

FIG. 5 is a schematic diagram of the second embodiment of the present invention;

FIG. 6 is a schematic diagram of the third embodiment of the present invention;

FIG. 7 is a schematic diagram of the fourth embodiment of the present invention.

FIG. 8 is a schematic diagram of the fifth embodiment of the present invention.

FIG. 9 is a schematic diagram of the sixth embodiment of the present invention.

### DETAILED DESCRIPTION OF THE PREFERRED EMBODIMENTS

To understand the technology, means and functions adopted in the present invention further, reference is made to the following detailed description and attached drawings. The invention shall be readily understood deeply and concretely from the purpose, characteristics and specification. Nevertheless, the present invention is not limited to the attached drawings and embodiments in following description.

To distinguish the file access rights management of the conventional operating system such as the UNIX-like OS, which uses user's identity or group's privilege setting, a method for examining the user's identity and/or the and/or administrating the access right(s) of a called function in a computer system of the present invention is provided. The method disclosed in the present invention is used for an administrator who is managing the user's identity and/or the access right(s) for accessing the documents or files in the function-level.

Particularly, as calling a managed called function, the executing process, task or thread is intercepted, and the related identification or authorization thereof is firstly performed, or even the authentication for the user is therewith operated. Since the mentioned access rights (rules) are examined, the called function can be functioned afterward. The access rights (rules) are provided to examine whether the called function is permitted to be executed or to be terminated according to user authentication, function parameters, application type, and/or the like.

In an embodiment of the present invention, a program loader is used to load a software application (with called function) in an operating system. The program loader generates a system call to load a software application (with called function), and an interception means is firstly intercepts the system call to modify the preceding operation codes of managed called function(s) within the software application when the software application is loaded into the system memory in the meanwhile. Wherein, the operation code can be the machine code or the byte code. Additionally, the interception can be make by periodically monitoring the Process List of operating system, searching the function(s) of software application within the memory, and backing up and modifying the preceding operation codes of managed function(s) to intercept the non-intercepted application function(s) and those functions which want to further intercept.

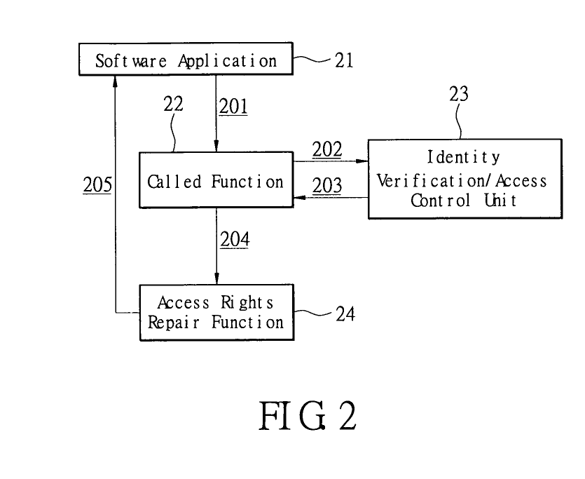

Reference is made to FIG. 2 showing a schematic diagram of the first embodiment illustrating a process of the method for examining a user's identity and/or administrating the access right(s) of a called function. In a user-mode or kernel-mode of the operating system, when the software application 21 calls a called function 22, the preceding operation codes having about 6 to 7 bytes of the called function are backed-up and modified before. Then, the preceding operation codes, such are Jmp or Call instructions, are executed (201) and the executing procedure is redirected to the memory addresses occupied by the identity verification/access control unit 23. Where the length and the system instruction of preceding operation codes are settled based on the processor type, such as Intel® x86 processor, ARM processor, MIPS processor or the like. Therefore, before the original called function is functioned, an identity verification/access control unit 23 is called to examine the identity verification or/and the access right(s) (202). Since the identity verification/access control unit 23 confirms the user's identity or/and the access right(s), the original preceding operation codes are restored, the return address (for called function) of the function-caller of the software application 21 is backed-up in the global variable, the return address of function-caller of software application 21 in the stack memory is modified to the address of a access rights repair function 24, and the executing procedure is addressed to execute the called function (203).

Furthermore, the preceding operation codes of the called function 22 can be re-backed-up and re-modified in the access rights repair function 24 after the called function executing process (204), and returned to the software application 21 according to the stored global variable with the return address of the function-caller of the software application 21 in the access rights repair function 24 afterward (205).

As an implementation of Intel® x86 processor is illustrated in the following example. Before a software application calls a called function, an interception means is used to scan the called function to be intercepted in the memory (step S301). The step of scanning the called function is processed periodically, after that, the preceding operation codes of the called function is backed up (step S303), and modified (step S305). Especially, since the software application calls a function, the return address of the function-caller of the software application will be pushed into the stack memory, and reach the next memory address where the software application calls, that is called function.

Since the preceding operation codes of the called function are replaced (modified), an identification verification and/or access right(s) examination are processed next (step S307). After confirming the user's identity and/or the access right(s) (step S309), the preceding operation codes thereof are restored to the original form (step S311). In the meantime, a returning address (for the called function) of the function-caller of the software application is backed-up and modified to the address of the access rights repair function, so the called function can transfer to the access rights repair function after executing the called function (step S313) before returning to the function-caller of the software application according to the backed-up return address.

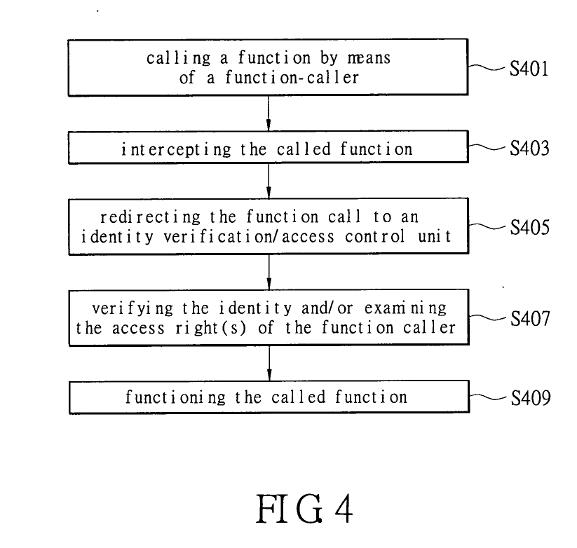

FIG. 4 shows a preferred embodiment of the present invention. The method for examining a user's identity and/or administrating the access right(s) of a called function comprises a step for calling a function by means of a function-caller, such as a software application installed in the operating system, in step S401, and the called function is intercepted (step S403). Wherein, the called function can be a function belonging to the software application, a system call of the operating system, a user-mode/kernel-mode function or the like.

An identity verification/access control unit is introduced to the method of the preferred embodiment. Then, the function call is redirected to the identity verification/access control unit in step S405. Thereby, the identity verification/access control unit is used to verify the identity of the function-caller and/or to examine the access right(s) of the function-caller (step S407). The step of examining the access right(s) of the preferred embodiment is to examine the parameter(s) for the called function or to examine the application type of the function-caller. After confirming the identity and/or the access right(s), the called function is functioned (step S409). That is, the called function is functioned if the function-caller's identity is verified and/or if the access right is authorized. More, the step of examining the access right is to examine whether the function-caller has right for reading or writing the volatile/non-volatile storage media, such as random access memory (RAM) or hard disk device.

Moreover, an intercepting means is introduced to process the step of intercepting the function call of the called function, and the intercepting means is used to modify the preceding operation codes of the called function as well and examine whether the called function can be functioned. Before the step of examining the access right(s), a process for a user authentication is introduced, such as user ID and password verification.

The method for administrating the access right(s) of the called function can be used to examine whether the user or the function-caller can use the called function to establish a network connection by checking the function call parameter(s), or to examine who or where the user or the function-caller can use the called function to make a network connection to, or to examine whether the user or the function-caller has right for accessing the memory space used for some specific application programs such as the Clipboard memory in the Microsoft® Windows operating system, or to examine whether a program-to-be-installed can be installed in an operating system. Furthermore, the administrating method provided by the present invention can manage the privilege of the user operating the peripheral devices, such as a flash driver, (external) volatile/non-volatile storage, or the like.

In view of the steps illustrated in FIG. 4 of the preferred embodiment, the intercepting means is to modify the operation code(s) of the intercepted called function and to redirect the executing procedure of the called function to the identity verification/access control unit.

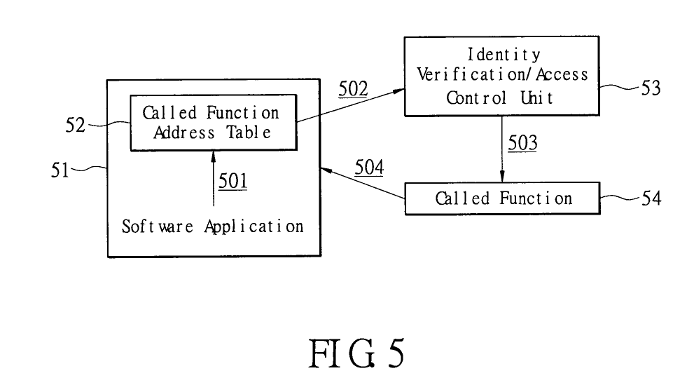

Reference of second embodiment is made to FIG. 5. The called function address table 52 within the software application 51 is modified to redirect the executing procedure to the identity verification/access control unit 53 while the software application 51 is loaded in the system memory. As the software application 51 calls the called function 54 (501), the executing procedure is redirected to the identity verification/access control unit 53 (502). That is to modify a corresponding entry of executable file dynamic library import table (52) so as to redirect the executing procedure to the identity verification/access control unit. Wherein, the import table is determined in accordance with the specific format of the execution files for different operating systems, virtual machine, or the like. An identity verification/access control unit 53 is used to examine the user's identity and/or the access right(s) to the called function. After confirming the user's identity and/or the access right(s) of the function-caller, the executing procedure will be transferred to the called function 54 (503), and the called function 54 will be executed. After executing the called function 54, the executing procedure is returned to the function-caller within the software application 51 (504).

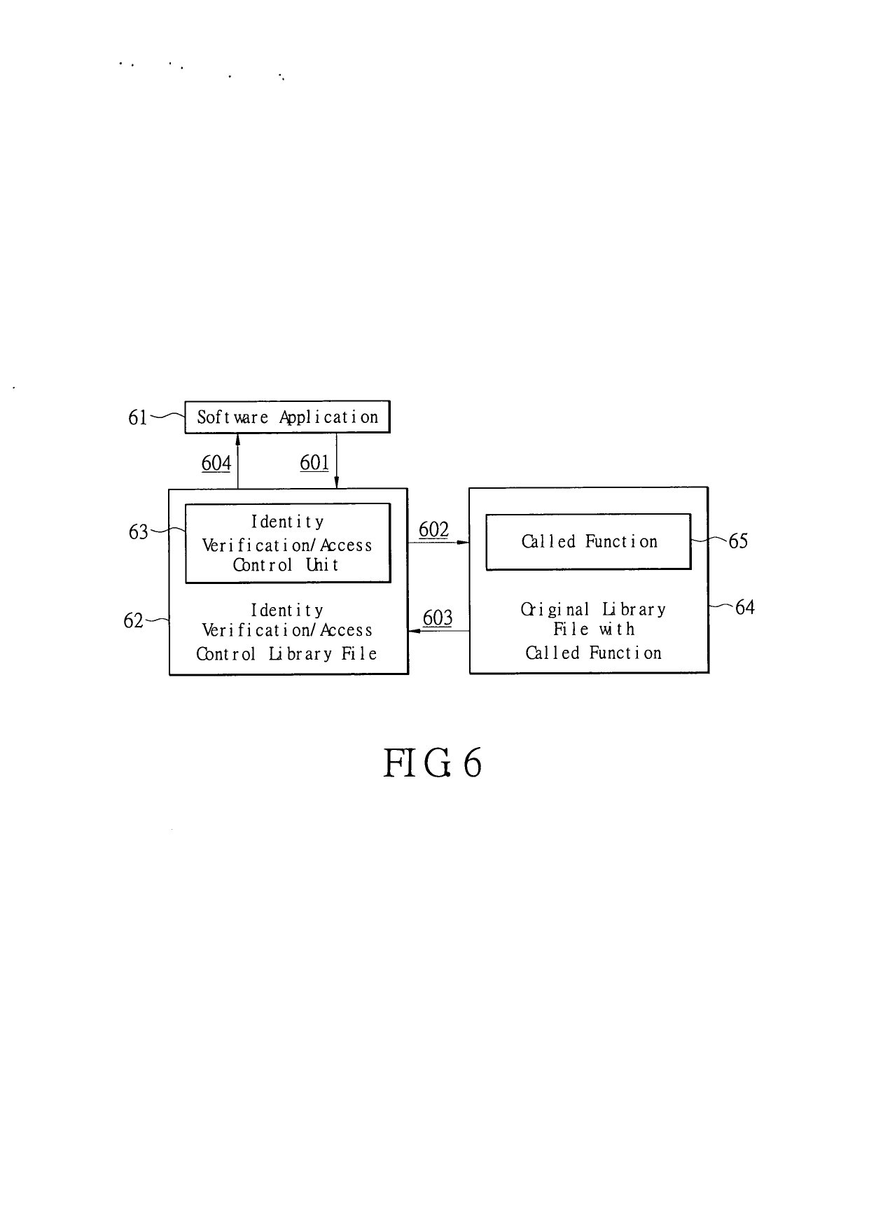

In third embodiment referring to FIG. 6, a method for replacing the library with called function to be intercepted is introduced to redirect the executing procedure to the identity verification/access control unit. Since the software application 61 calls a called function 65 (601), an external identity verification/access control library file 62 with the identity verification/access control unit 63 will be loaded. The original library file with called function 64 is replaced by the external identity verification/access control library file 62 with the dummy called function. In other words, that is the original library file path and file name was used by the identity verification/access control library file 62. The identity verification/access control unit 63 is used to examine a user's identity and/or the access right(s) to the called function 65 when the dummy called function is executed instead of the original called function, and then confirm the user's identity and/or the access right(s) of the function-caller. After confirming the user's identity and/or the access right(s), the executing procedure can transfer to the original called function (602) and return to the identity verification/access control unit 63 after executing the original called function (603). Finally, returning to the function-caller within the software application 61 (604).

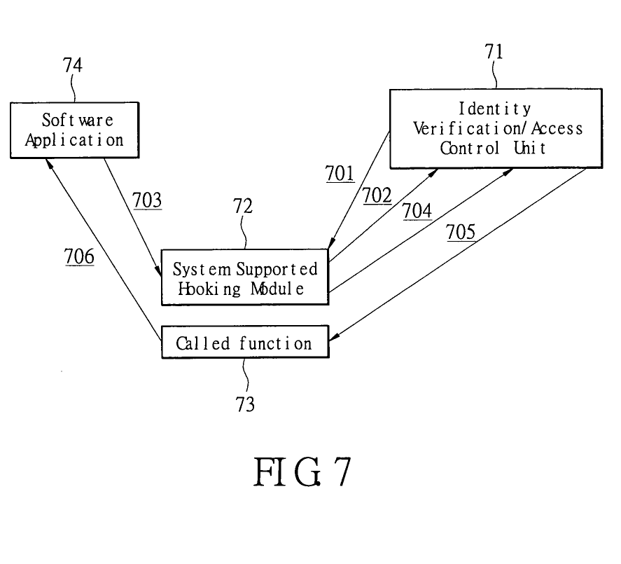

Next, a callback function provided by a system is introduced to redirect the function call to the identity verification/access control unit. Reference is made to FIG. 7 showing a fourth embodiment of the present invention.

If a computer system already provides an interception (hooking) mechanism, the identity verification/access control unit, such as the identity verification/access control unit 71, located in a local or a remote computer system can registers a (callback) function or an event from a system supported hooking module 72 via a registering function (701, 702). After that, when a software application 74 triggers a related function call or event (703), the system supported hooking module 72 will call the callback function of the identity verification/access control unit 71 for the identity verification and/or access rights control (704). After confirming the user's identity and/or the access right(s) to the called function (705), the corresponding called function 73 therefore executes and returns to the function-caller within the software application 74 (706). That is, the user's identity verification and/or the access control can be processed from the remote computer system as well as the step processed in the local computer system. Furthermore, the identity verification/access control unit logs the access information of the function-caller to the local/or remote storage as well.

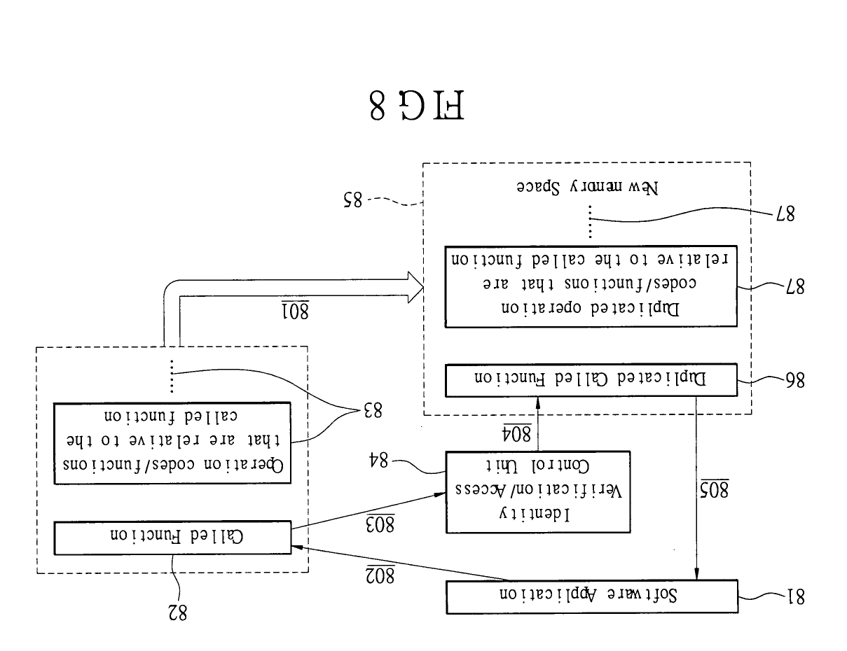

Reference of fifth embodiment is made to FIG. 8. The operation codes of the called function 82 and/or the whole/partial operation codes 83 relative to the called function 82 are duplicated to a new memory space 85 (801). Wherein, the new memory space 85 may be within the identity verification/access control unit 84. And the called function 82 is modified to redirect the executing procedure to the identity verification/access control unit 84. As the software application 81 calls the called function 82 (802), the executing procedure is redirected to the identity verification/access control unit 84 (803). An identity verification/access control unit 84 is used to examine the user's identity and/or the access right(s) of the function-caller. After confirming the user's identity and/or the access right(s) of the function-caller, the executing procedure will be transferred to the duplicated called function 86 (804), and the duplicated called function 86 will be executed. After executing the duplicated called function 86, the executing procedure is returned to the function-caller within the software application 81 (805).

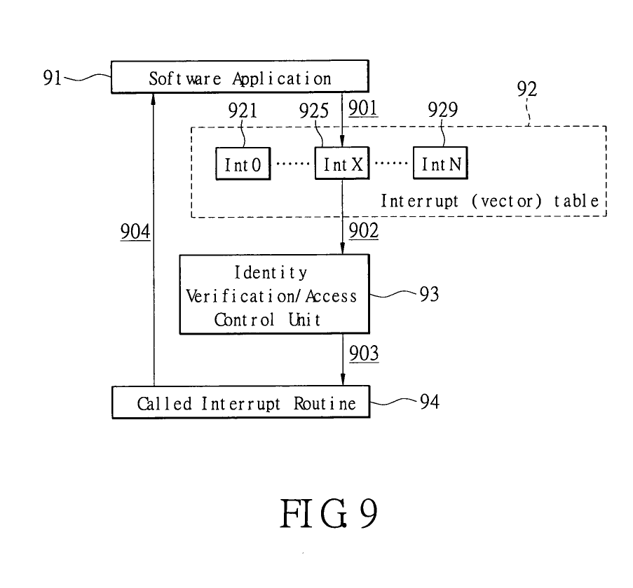

Reference of sixth embodiment is made to FIG. 9. The interrupt routine address of the entry Int×925 of the interrupt (vector) table 92 is modified to redirect the executing procedure to the identity verification/access control unit 93. As the software application 91 calls the called interrupt routine (901), the executing procedure is redirected to the identity verification/access control unit 93 (902). An identity verification/access control unit 93 is used to examine the user's identity and/or the access right(s) of the interrupt routine-caller. After confirming the user's identity and/or the access right(s) of the interrupt routine-caller, the executing procedure will be transferred to the original interrupt routine 94 (903), and the original interrupt routine 94 will be executed. After executing the original interrupt routine 94, the executing procedure is returned to the interrupt routine-caller within the software application 91 (904).

The above-mentioned access right is examined by means of a plurality of access rights rules, where the access rights rules are configured in an operating system in advance, or dynamically configured in an operating system. The access rights rules are obtained by an operating system via a peripheral device of a computer system, or by accessing a remote computer system via a network connection.

The many features and advantages of the present invention are apparent from the written description above and it is intended by the appended claims to cover all. Further, since numerous modifications and changes will readily occur to those skilled in the art, it is not desired to limit the invention to the exact construction and operation as illustrated and described. Hence, all suitable modifications and equivalents may be resorted to as falling within the scope of the invention.

What is claimed is:

1. A method for administrating a function access, comprising:
modifying the preceding operation codes of a called function;
calling the called function causing the executing procedure to be redirected to an identity verification/access control unit; and
examining a user's identity and/or the access right of a function-caller.

2. The method as recited in claim 1, wherein the method further comprises a step of backing up the preceding operation codes of the called function before modifying the preceding operation codes of the called function.

3. The method as recited in claim 2, wherein the method further comprises a step of restoring the preceding operation codes and executing the called function after examining the user's identity and/or the access right of the function-caller.

4. The method as recited in claim 2, wherein the method further comprises a step of executing the called function by using the backed up preceding operation codes first, and then transferring the executing procedure to the next operation code of the preceding operation codes of the called function after examining the user's identity and/or the access right of the function-caller.

5. The method as recited in claim 1, wherein the method further comprises:
a step of duplicating the operation codes of the called function and/or the whole or partial operation codes that are relative to the called function to a new memory space before modifying the preceding operation codes of the called function; and
a step of executing the duplicated called function in the new memory space after examining the user's identity and/or the access right of the function-caller.

6. The method as recited in claim 1, wherein a pre-interception unit is used to periodically monitor a Process List of an operating system, and to search the function of a software application within the memory, and to modify the preceding operation codes of the managed function.

7. The method as recited in claim 2, wherein the steps of backing up and modifying the preceding codes of the called function are made while a program loader is used to load the software application with the called function.

8. The method as recited in claim 1, wherein the step of examining the access right is performed according to access rights rules.

9. The method as recited in claim 2, wherein after confirming the user's identity and/or the access right, the method further comprises:
restoring the original preceding operation codes;
backing up a return address of the function-caller of a software application to a variable;
modifying the return address of the function-caller of the software application in the stack memory to the address of a access rights repair function;
addressing the executing procedure to execute the called function;
executing the access rights repair function after the called function is returned since the return address of stack memory was modified; and
returning to the software application according to the stored variable with the return address of the function-caller of the software application.

10. A method for administrating a function access, comprising:
modifying a called function address table of execution file in the memory, wherein the called function address table records the address to execute while calling the called function;
calling the called function;
redirecting the executing procedure to an identity verification/access control unit;
examining a user's identity and/or the access right of a function-caller;
confirming the user's identity and/or the access right of the function-caller;
transferring the executing procedure to the called function; and
executing the called function.

11. The method as recited in claim 10, wherein the step of modifying the called function address table is to modify a corresponding entry of an executable file dynamic library import table.

12. The method as recited in claim 10, wherein the called function address table is determined in accordance with the specific format of the execution files.

13. A method for administrating a function access, comprising:
replacing an original library file with a called function by an identity verification/access control library file;
calling the called function;
loading the external identity verification/access control library file with a dummy called function if the called function doesn't exist in the memory space;
examining a user's identity and/or the access right of a function-caller when the dummy called function is executed instead of the original called function;
confirming the user's identity and/or the access right of the function-caller;
transferring the executing procedure to the original called function; and
executing the original called function.

14. A method for administrating a function access, wherein a hooking mechanism is provided by a computer system, comprising:
registering a callback function from a system supported hooking module;
triggering a function call related to the callback function;
calling the callback function of an identity verification/access control unit in the hooking mechanism;
examining a user's identity and/or the access right of a function-caller;
confirming the user's identity and/or the access right of the function-caller;
transferring the executing procedure to the called function; and
executing the corresponding called function.

15. A method for administrating a function access, comprising:
replacing an interrupt routine address of the interrupt (vector) table by the address of a new handling routine;
calling a called interrupt routine;
jumping to the new handling routine to check if the processor register(s) and/or parameter(s) in memory are the wanted value(s) to hook and/or examine a user's identity and/or the access right of a interrupt-routine-caller;
confirming the checking result of the processor registers and/or parameters in memory, and the user's identity and/or the access right of the interrupt-routine-caller;
transferring the executing procedure to the original interrupt routine; and
executing the original interrupt routine.

16. A method for administrating a function access, comprising:
taking a pre-interception action for processing a executing procedure to an identity verification/access control unit;
calling a called function by a function-caller means;
redirecting the executing procedure to the identity verification/access control unit;
verifying the identity and/or examining the access right of the function-caller; and
functioning the called function;
wherein, the identity verification/access control unit is used for examining whether the called function can be functioned.

17. The method as recited in claim 16, wherein the step of processing the executing procedure includes a step of intercepting or a step of redirecting.

18. The method as recited in claim 16, wherein the pre-interception action means is to modify the preceding operation codes of the intercepted called function and to redirect the executing procedure of the called function to the identity verification/access control unit.

19. The method as recited in claim 16, wherein a method for modifying a corresponding entry of an executable file dynamic library import table is introduced to redirect the executing procedure to the identity verification/access control unit.

20. The method as recited in claim 16, wherein a method for replacing the library with the called function to be intercepted is introduced to redirect the executing procedure to the identity verification/access control unit.

21. The method as recited in claim 16, wherein a callback function provided by a system is introduced to redirect the executing procedure to the identity verification/access control unit.

22. The method as recited in claim 16, wherein a method for modifying a corresponding entry of an interrupt routine address of the interrupt table is introduced to redirect the executing procedure to the identity verification/access control unit.

23. The method as recited in claim 16, wherein the identity verification/access control unit is located in a local computer system.

24. The method as recited in claim 16, wherein the identity verification/access control unit is located in a remote computer system.

25. The method as recited in claim 16, wherein the step of taking the pre-interception action is processed since a program loader of an operating system loads a software application.

26. The method as recited in claim 16, wherein the step of taking the pre-interception action is processed since a pre-interception unit is used to monitor a process list existed in the operating system periodically.

27. The method as recited in claim 16, wherein the called function is functioned if the function-caller's identity is verified.

28. The method as recited in claim 16, wherein the called function is functioned if the access right is authorized.

29. The method as recited in claim 16, wherein the step of examining the access right is to examine a user's identity.

30. The method as recited in claim 16, wherein the step of examining the access right is to examine the parameter(s) for the called function.

31. The method as recited in claim 16, wherein the step of examining the access right is to examine an application type of the function-caller.

32. The method as recited in claim 16, wherein the access right is examined by means of a plurality of access right rules.

33. The method as recited in claim 32, wherein the access right rules are configured in advance.

34. The method as recited in claim 32, wherein the access right rules are dynamically configured.

35. The method as recited in claim 32, wherein the access right rules are obtained by accessing the local volatile/non-volatile storage of a computer system.

36. The method as recited in claim 32, wherein the access right rules are obtained by accessing a remote computer system via a network.

37. The method as recited in claim 16, wherein before the step of examining the access right, a process for a user authentication is introduced.

38. The method as recited in claim 16, wherein the step of examining the access right is to examine whether the function-caller has right for reading or writing the volatile or non-volatile storage media by using the called function.

39. The method as recited in claim 16, wherein after the step of verifying the identity and/or the step of examining the access right, the function-caller is examined whether it can use the called function to establish a network connection by checking the function call parameter(s), or to examine who or where the user or the function-caller can use the called function to make a network connection to.

40. The method as recited in claim 16, wherein after the step of verifying the identity and/or the step of examining the access right, the function-caller is examined whether the function-caller has right for accessing the memory space used for a program.

41. The method as recited in claim 16, wherein after the step of verifying the identity and/or the step of examining the access right, the function-caller is examined whether it can install a program-to-be-installed in a computer system.

42. The method as recited in claim 16, wherein the called function is a function belonging to a software application.

43. The method as recited in claim 16, wherein the called function is an interrupt routine.

44. The method as recited in claim 16, wherein the called function is a user-mode function.

45. The method as recited in claim 16, wherein the called function is a kernel-mode function under a supervisor mode of a processor.

46. The method as recited in claim 16, wherein the identity verification/access control unit logs the access information of the function-caller to the local or remote storage.
